(19) United States
(12) Patent Application Publication
(10) Pub. No.: US 2003/0079359 A1
(43) Pub. Date: May 1, 2003

(54) Tube diameter gage assembly

(76) Inventor: John E. Richards, Kettering, OH (US)

Correspondence Address: Killworth, Gottman, Hagan & Schaeff, L.L.P., Suite 500, One Dayton Center, Dayton, OH, 45402-2023, US

(21) Appl. No.: 10/021,229

(22) Filed: Oct. 30, 2001

(51) Int. Cl. G01B 5/08

(52) U.S. Cl. 33/555.1

(57) ABSTRACT

A gage assembly to measure the diameter of a piece of tubing. The gage assembly is especially configured to take measurements during the extrusion manufacture of the tubing when an eccentricity in the outer diameter of the tubing is present. The gage assembly includes a pair of contact wheels mounted such that the space between them defines a path with a diamond-shaped cross section for the tubing to pass through. Each contact wheel includes cutouts that define a pair of planar contact surfaces that are angularly disposed relative to one another. As the tubing leaves the extruder, it axially passes through the diamond-shaped path, coming in contact with the planar surfaces of the contact wheels. The contact wheels are slidably and rotatably mounted such that translational movement imposed on the planar surfaces of the wheels due to eccentricities on the tubing outer surface are resolved into movement along a first translational direction, which is correlated to the size of the undulation in the tubing, then registered as output on an indicator. The angular positioning of the planar contact surfaces to one another permits the simultaneous measurement in two dimensions on the outer surface of the tubing, while the slidable mounting of the contact wheels ensures continued contact between both planar surfaces of each wheel and the tubing outer surface.

### BACKGROUND OF THE INVENTION

The present invention relates generally to a gage assembly to measure the diameter of tubing, even when eccentricities are present, and more particularly to a gage assembly that can directly measure such diameters with eccentricities present in extruded tubing while the tubing is either stationary or as it is moving past the assembly during the extrusion process.

The use of a gage to measure dimensions of manufactured parts is well known. In the subset of measuring devices used for axisymmetric, or circular cross-section, workpieces, a movable gage is disposed against the workpiece, and upon relative movement between the two, variations in the workpiece outer dimension are sensed and recorded. In manufacturing situations where the workpiece is tubular, such as with pipe, tubing and related structure, a major area of concern is with the dimensional consistency of the finished product. In the present context, the term “tubing” or “tubular” refers to all generally elongate devices with a wall and a centrally disposed conduit-like passageway. For the sake of the measurement device discussed herein, the measurement of the outer dimensions of solid cylindrical rods, while not truly tubular in structure, could also be performed. Manufacturers have traditionally placed particular emphasis on being able to rapidly and accurately measure workpiece variations so that manufacturing defects can be corrected at the point of manufacture in order to minimize loss in product quality or manufacturing down-time. In addition to allowing for timely correction in the event defects are found, greater measurement throughput is possible when the workpiece is being transported past an inspection point, rather than to inspect it once it has already been stacked or stored.

The dilemma in current art gages is that they are either too fragile to withstand the amount of use required in the production of vast quantities of product, or they are very rugged, but are unable to accurately sense fine-level deviations. In addition, current gages measure extruded tubing at a single, discreet radial location. As such, they do not give an accurate indication of the overall tube diameter and periphery, thus providing no knowledge of tube dimensions in the event the tube is forced back to round through subsequent machining or post-production forming steps.

Consequently, what is needed is a device that is capable of accurately measuring the diameter of a workpiece at multiple locations around the workpiece periphery as the workpiece is being manufactured. Furthermore, the need extends to the reliable, long-term measurement of large as-produced quantities of axisymmetric workpieces.

### SUMMARY OF THE INVENTION

This need is met by the present invention wherein a gage assembly without the disadvantages of the prior art is described. The gage assembly of the present invention can be used to measure two diameters at rights angles to one another on the surface of a workpiece while that workpiece is being extruded. This simultaneous measurement of two positions on the outer surface of a tube can provide valuable “x-y” mapping information to determine if the extrusion process needs modification. In addition, the two orthogonal measuring locations are averaged, so that the tubing manufacturer can determine whether tolerances are met, and what would be the actual diameter of the tubing once that tubing is forced back to “round”.

In accordance with one embodiment of the present invention, a gage assembly includes a workpiece engaging mechanism, a mounting mechanism, and an indicator. The workpiece engaging mechanism includes a plurality of contact members each defining one or more surfaces configured to contact the workpiece. These contact members are disposed substantially adjacent one another such that between them is defined a workpiece travel zone. As used in conjunction with the present disclosure, the term “substantially” refers to an arrangement of elements or features that, while in theory would be expected to exhibit exact correspondence or behavior, may, in practice embody something slightly less than exact. It is important to note that the way the contact members are mounted to the mounting mechanism, they are capable of translational motion along two orthogonal axes relative to one another such that contact between the outer surface of the workpiece and all four planar surfaces is maintained, even if the workpiece is out of round. The mounting mechanism is used to convert the relative movement between the contact members into linear motion capable of being read out to an indicator. One part of the mounting mechanism holds a first contact member stationary along a first translational axis, while another part of the mounting mechanism holds a second contact member biased such that the two contact members are moveable relative to one another along the first translational axis to accommodate the insertion of a workpiece therebetween. When a substantially rigid workpiece is inserted into the workpiece travel zone, and a surface undulation in the workpiece is brought into contact with one or more surfaces of at least one of the contact members, the undulation pushes against the contact member surface(s), which in turn forces the second contact member and its associated part of the mounting mechanism to move along the first translational direction. The indicator is in signal communication with the mounting mechanism, and is responsive to movement imparted to it by the relative motion of the two contact members caused by the workpiece undulation. Accordingly, the indicator is capable of registering output commensurate with the size of the undulation. In the present context, the term “signal” is used in a broad sense to include any positional information capable of being transported from mounting mechanism the workpiece travel zone to the indicator, rather than limiting it to its traditional electrical, optical or acoustic form. For example, by providing a mechanical contact between two separate members such that displacement “information” imparted on one is transferred to the other through the mechanical contact, the mechanical contact establishes “signal” communication between the first and second members.

Optional features include rotatable mounting of the contact members such that, the contact members can rotate in response to contact with the workpiece. It will be understood that the workpiece can be, but is not limited to, hollow tubing or a generally cylindrical rod. Preferably, the contact members are wheels that have their workpiece contacting surfaces defined by a cutout comprising a pair of planar surfaces disposed at substantially right angles to one another. As such, the contact members are in a substantially parallel arrangement with one another, such that their respective axes of translation are substantially parallel. The workpiece travel zone defined by adjacent placement of the two wheels is shaped such that each planar surface of the first wheel is diametrically opposed to one of the planar surfaces of the second wheel. Furthermore, each of the wheels is slidably disposed along an axial shaft within the mounting mechanism. This allows each of the wheels to axially translate along the shaft (i.e.: along a second translational axis) in response to contact with the workpiece. This helps to maintain contact between both planar surfaces of each wheel and the workpiece. Also, the first translational axis is substantially aligned with a back and forth motion of the moving portion of the mounting mechanism along its sliding direction. The moving portion of the mounting mechanism further can include a surface angled relative to the first translational axis such that a roller attached to the indicator can travel along this angled surface to communicate translational motion along the first translational axis of the moving portion of the mounting mechanism to the indicator. Preferably, this angled surface is disposed relative to the translational axis approximately 35 degrees, and more particularly 35 degrees, 15 minutes and 51.8 seconds. By virtue of this angular relationship, conventional dial gages can convert the movements imparted to the four contact points between the workpiece and the planar surfaces of the contact wheels to a diameter measurement. The portions of the mounting mechanism are preferably made up of a stationary base and a slidable base, where the slidable base translates relative the stationary base along the first translational axis. The mounting mechanism can be further defined by a stationary pillow block and a slidable pillow block, each mounted to their respective base to establish connection between the base and a respective shaft-mounted wheel. The gage assembly can further include a tension control unit to permit adjustable contact between the indicator and the slidable base. Preferably, the output to the indicator is visually recognizable, and in human-readable form.

According to another embodiment of the present invention, a gage assembly for the measurement of tubing is disclosed. The gage assembly includes a stationary mounting member, a slidable mounting member, a pair of contact wheels, and an indicator. The slidable mounting member can translate back and forth relative to the stationary mounting member along a first translational axis, and has one of the contact wheels coupled to it, while the stationary mounting member has the other contact wheel coupled to it. The two contact wheels are disposed adjacent one another such that a tubing travel zone is defined by the space therebetween. The indicator is operatively coupled to the slidable mounting member such that relative movement caused between the two mounting members due to the passage of an undulated section of tubing or rod through the tubing travel zone is converted to an output in the indicator.

Optionally, the tubing travel zone is further defined by a cutout in each of the first and second contact wheels, where each of the cutouts comprise a pair of planar surfaces disposed at substantially right angles to one another. Preferably, the tubing travel zone is shaped such that each planar surface of the pair of planar surfaces on the first contact wheel is diametrically opposed to a planar surface on the second contact wheel. Furthermore, each of the contact wheels are slidably disposed along an axial shaft within the mounting mechanism, thereby defining a second translational axis orthogonal with the first translational axis such that each of the contact wheels can translate along the shaft in response to contact with the tubing in order to maintain contact between both of the planar surfaces of each contact wheel and the tubing. The displacement registered as the output in the indicator is a direct correlation to a change in the outer diameter of the tubing caused by the undulated section of tubing inserted into the tubing travel zone, as such undulated section causes differential movement between the two wheels along one or both translational axes.

According to another embodiment of the present invention, a gage assembly for the measurement of axisymmetric tubing is disclosed. The gage assembly includes a base plate, a stationary pillow block base, a slidable pillow block base and an indicator. The stationary pillow block base is mounted to the base plate, and includes a plurality of spaced-apart pillow blocks mounted thereon. A first contact wheel is slidably and rotatably disposed along an axial shaft that is mounted between the spaced-apart pillow blocks on the stationary pillow block base. The first contact wheel includes a tubing contact surface defined by a cutout comprising a pair of planar surfaces angularly disposed relative to one another. The slidable pillow block base is removably disposed on the base plate, and can translate back and forth along a sliding direction that is co-linear with a first translational axis. The slidable pillow block base includes a plurality of spaced-apart pillow blocks mounted thereon. A second contact wheel is slidably and rotatably disposed along an axial shaft that is mounted between the spaced-apart pillow blocks on the slidable pillow block base. The second contact wheel includes a tubing contact surface defined by a cutout comprising a pair of planar surfaces angularly disposed relative to one another in a manner similar to that of the first contact wheel. The juxtaposition of the first and second wheels define a tubing travel zone through which a piece of tubing or rod may be inserted for measurement. The indicator is operatively responsive to the slidable movement in the slidable pillow block base caused by the passage of the tubing through the tubing travel zone. The slidable connection between the wheels and their respective shaft is such that each of the contact wheels can translate along the shaft in response to contact with the tubing in order to maintain contact between all of the planar surfaces and the tubing.

Optionally, at least one surface of the slidable pillow block base is angularly disposed relative to the direction of the slidable movement in the slidable pillow block base in a manner similar to that of the first embodiment. Moreover, the angularly disposed surface is angled between 30 and 40 degrees relative to the direction of slidable movement, and is preferably angled approximately 35 degrees relative to the direction of slidable movement. In addition, a handle is disposed on the slidable pillow block base to facilitate adjustments between at least the slidable and stationary pillow block bases. The gage assembly can further comprise an adjustable guide in cooperation with the slidable pillow block base, and a stationary guide in cooperation with the slidable pillow block base to accommodate tubing of various diameters. A tension control unit can be included to permit adjustable contact between the indicator and the slidable pillow block base. As with the previous embodiments, the surfaces in each of the contact wheels are disposed at substantially right angles to one another. Furthermore, the first and second contact wheels are slidably disposed along an axial shaft that extends between the pillow blocks such that each of the contact wheels can translate along the shaft in response to contact with the tubing in order to maintain contact between both of the planar surfaces of each wheel and the tubing.

According to another embodiment of the present invention, a method of measuring a workpiece for undulations in its surface is disclosed. The method includes configuring a workpiece measurement device, receiving a portion of the workpiece into the workpiece travel zone and measuring the portion of the workpiece to determine the presence or absence of any of the surface undulations. The workpiece measurement device used to perform the measurement includes a workpiece engaging mechanism, a mounting mechanism and an indicator. The workpiece engaging mechanism comprises a first contact member defining a first workpiece contact surface and a second contact member defining a second workpiece contact surface. The second contact member can be moved relative to the first contact member and is disposed substantially adjacent the first contact member such that a workpiece travel zone is defined by the space therebetween. The mounting mechanism is coupled to the workpiece engaging mechanism such that, upon contact between a surface undulation on the workpiece and the workpiece engaging mechanism, relative movement between the first and second contact members proportional to the surface undulation is imparted to at least a portion of the mounting mechanism along at least a first translational axis. The indicator is cooperatively engaged with the mounting mechanism such that relative movement imparted to it from an undulation in the workpiece via the workpiece engaging mechanism and mounting mechanism is converted to an output that can be read by a human operator, or sent to another information display or storage device.

Optionally, the method includes the step of receiving a portion of the workpiece into a workpiece travel zone as the tubing is coming out of an extruder. This permits real-time measurement and detection of out-of-tolerance parts, thereby enabling an operator to shut down production until the correction is made. This has the benefit of being much more time and cost effective than waiting to measure the workpiece until after it has been cut, stacked or stored. Alternatively, the measurement can be made while the workpiece is stationary. Preferably, as with the previous embodiments, each of the first and second contact members includes a pair of planar surfaces disposed at substantially right angles relative to one another such that each planar surface is aligned to contact an outer surface of the workpiece, thereby permitting the contact member to rotate in response to moving contact with the workpiece. In addition, each of the contact members are slidably disposed within the mounting mechanism to maintain contact between both of the pair of planar surfaces of each contact member and the workpiece, thereby facilitating simultaneous measurement of substantially orthogonal surface directions of the workpiece.

### BRIEF DESCRIPTION OF THE SEVERAL VIEWS OF THE DRAWINGS

FIG. 1 is an elevation view of a gage assembly according to an embodiment of the present invention, showing the relative placement between the tubing to be measured and the gage assembly;

FIG. 2 is top view of the gage assembly and tubing shown in FIG. 1, looking axially along a piece of manufactured tubing;

FIG. 3 is a top view of a gage assembly according to an alternate embodiment of the present invention;

FIG. 4A is a simplified top view showing a piece of tubing with no surface undulations being measured by gage assembly according to an embodiment of the present invention, and how orthogonal surfaces of each contact wheel are in continual contact with an outer surface the tubing, as well as the relative position between the two wheels; and

FIG. 4B is a simplified top view showing a piece of tubing with an undulated surface being measured by gage assembly according to an embodiment of the present invention, and how orthogonal surfaces of each contact wheel remain in continual contact with the tubing outer surface, as well as a change in the relative position between the two wheels due to the undulation.

### DETAILED DESCRIPTION OF THE PREFERRED EMBODIMENTS

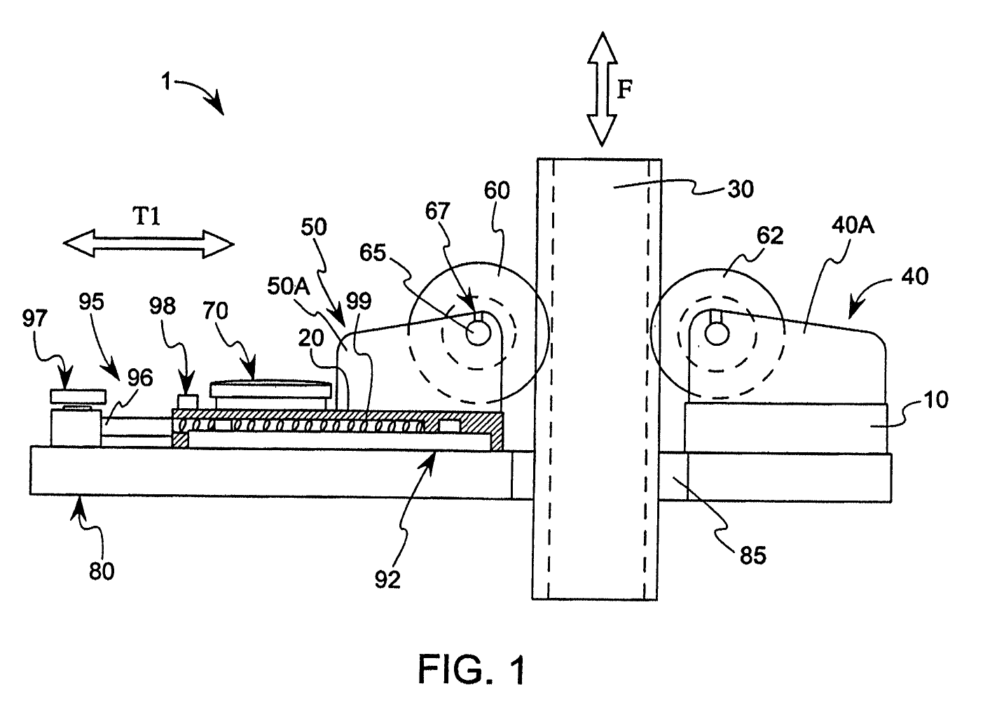

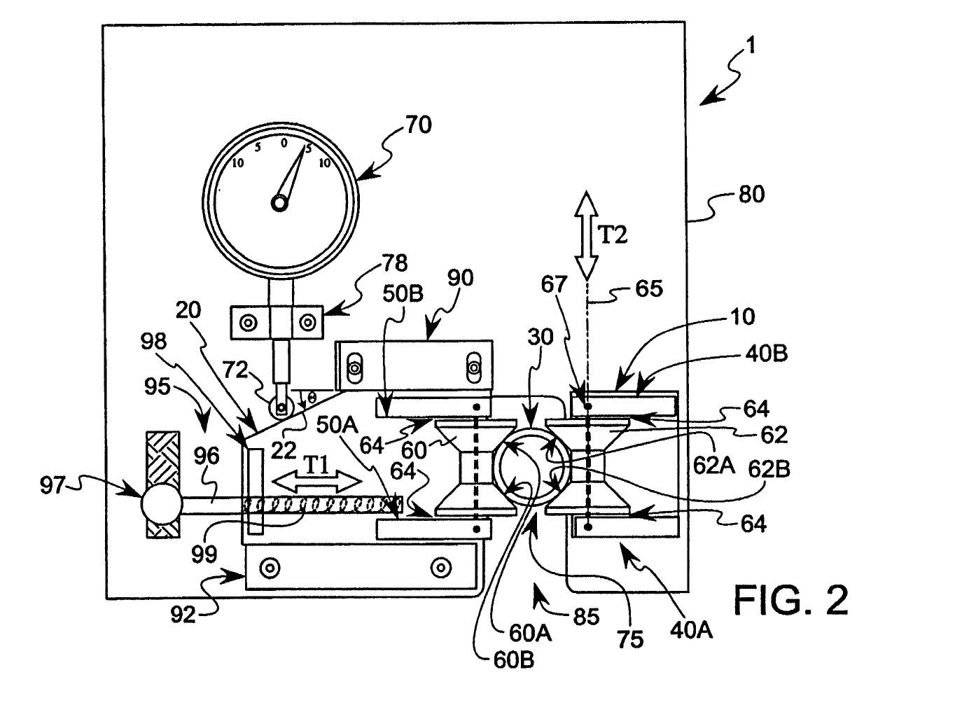

With reference to FIG. 1, a gage assembly 1 includes a mounting mechanism made up of a stationary pillow block base 10 (alternately referred to as a stationary mounting member) and a slidable pillow block base 20 (alternately referred to as a slidable mounting member) horizontally spaced apart from one another by an amount sufficient to allow the passage of a manufactured workpiece 30, such as a piece of extruded tubing, along workpiece feed axis F. A pair of pillow block sets 40, 50 are coupled to respective pillow block bases 10 and 20. Contact wheels 60, 62 (collectively referred to as a workpiece engaging mechanism) are rotatably mounted between the pillow block members of each pillow block set via shaft 65. Adjustments to contact wheels 60, 62 are made through set screw 67. The entire assembly 1 is mounted to base plate 80. An opening 85 within base plate 80 permits manufactured workpiece 30 to pass through the assembly 1, engaging contact wheels 60, 62 on its way to a subsequent storage or segmenting device (not shown). An indicator 70 (shown in more detail in FIG. 2) is coupled to slidable pillow block base 20 to enable human-readable or machine-recordable output corresponding to the diameter of workpiece 30. This indicator can be a simple analog dial, light-emitting diode (LED) or comparable indicator as known to those skilled in the art, as well as a conventional digital data storage device (not shown). The slidable pillow block base 20 is secured to base plate 80 through adjustable guide 90 (not presently shown) and stationary guide 92, and is capable of back and forth sliding motion along a first translational axis T1. Different spring loads can be set via tension control unit 95, which is made up of pushrod 96, adjustment knob 97, handle 98 and spring 99. By adjustment of slidable pillow block base 20 relative to roller 72 (shown in FIG. 2 as discussed in more detail below), positive contact between the two, with substantially error-free operation, is ensured. The adjustable feature of tension control unit 95 also allows the indicator 70 to be calibrated to zero for workpieces of various diameters with minimal effort.

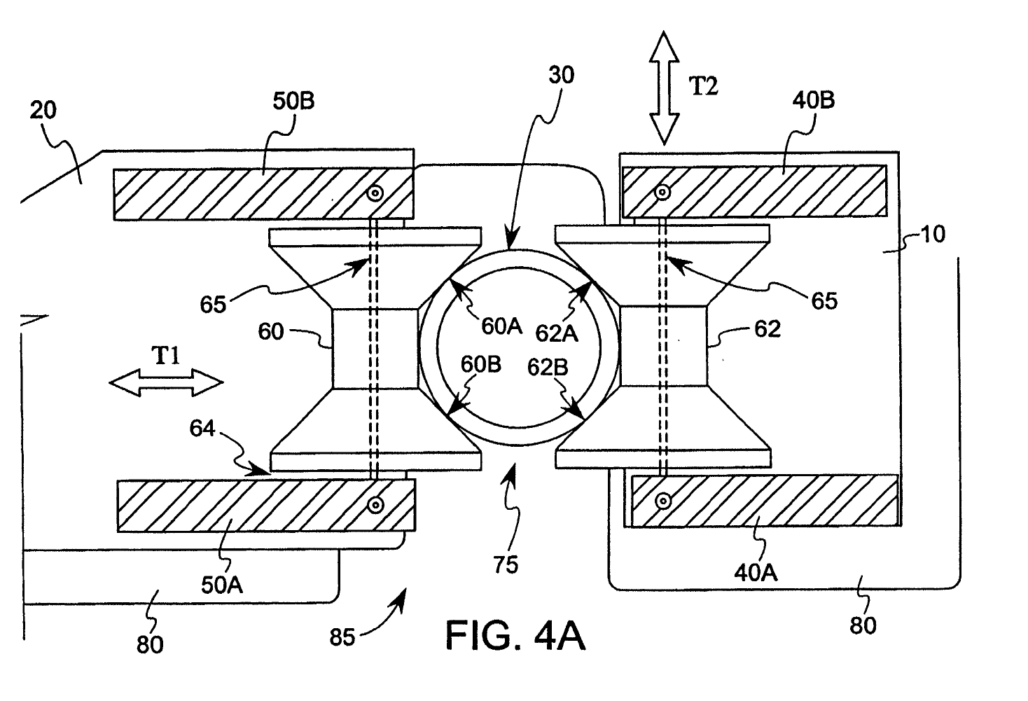

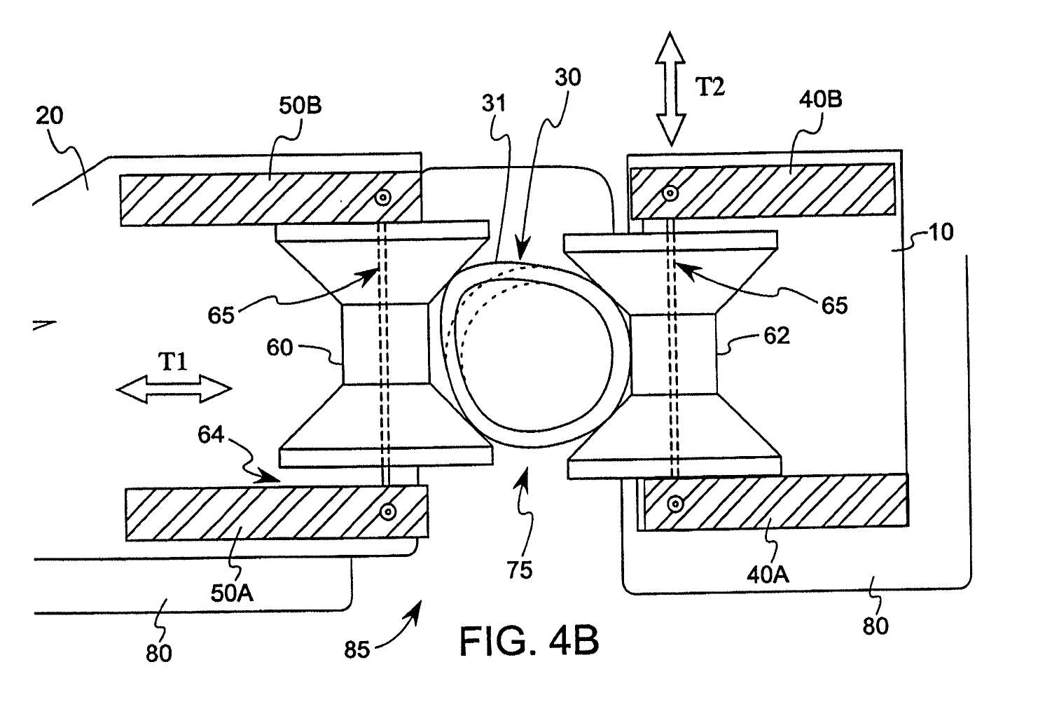

Referring now to FIG. 2, each pillow block set 40, 50 is defined by substantially parallel-spaced pillow block members 40A, 40B and 50A, 50B. Shaft 65 extends between each respective set, and includes a travel length that is slightly longer than the axial length of contact wheels 60 and 62 such that the wheels can slide along second translational axis T2 defined along shaft 65. Movement imparted substantially equally to both contact wheels (such as due to minor wiggling motion caused by the passage of the tubing through workpiece travel zone 75) is taken up by slight clearance 64 between the axial ends of each wheel 60, 62 and its corresponding pillow block members, due to the aforementioned difference in shaft 65 length and wheel 60, 62 length. Contrarily, movement imparted differently to the surfaces of the two wheels is transferred to indicator 70, as the movement along the first and second translational axes T1 and T2 is resolved into a first translational axis T1 component due to cutaway grooves in the radially-extending portion of each wheel that define angled planar surfaces 60A, 60B and 62A, 62B. The pair of angled planar surfaces 60A, 60B in wheel 60 and 62A, 62B in wheel 62 are disposed at right angles to one another, and are configured to contact the outer portions of the workpiece 30. The compliance inherent in clearance 64 ensures that the four angled planar surfaces 60A, 60B and 62A, 62B that define the contact between the workpiece 30 and the contact wheels 60, 62 are always in contact with the workpiece 30, even if the workpiece is out of round. The contact wheels 60, 62, in addition to their generally axial projection along second translational axis T2, are defined by a generally radial extension along first translational axis T1. Accordingly, the contact wheels 60, 62, when viewed as shown, define a generally spool or angled hourglass shape. A workpiece travel zone 75 (alternately referred to as a tubing travel zone) is formed by the substantially square (or diamond) shaped space between the juxtaposed angled planar surfaces 60A, 60B of wheel 60 and 62A, 62B of wheel 62, where the opposing top and bottom corners are left slightly open, depending on the size of the tubing being measured. Accordingly, in the present context, a diamond-shaped workpiece travel zone need not be perfectly square, but may have open gaps at opposing corners, as shown in the figure, to allow for variations in the size of the tubing. In addition, as discussed with regard to FIGS. 4A and 4B below, the two different translational degrees of freedom (along both the first and second translational axes T1 and T2) will allow workpiece travel zone 75 to deviate from its diamond shape while in the presence of a surface undulation in the workpiece 30. Indicator 70 cooperates with the contact wheels 60, 62 through slidable pillow block base 20 and roller 72. The angled surface 22 on slidable pillow block base 20 permits the roller 72, which has movement along the first translational axis T1 restrained by bracket 78, to convert the translational movement associated with an undulation on the surface of the tubing into direct correlation registered on indicator 70. When the diameter of workpiece 30 passing through the workpiece travel zone 75 is not out-of-round, no relative motion occurs between the contact wheels 60, 62 along either of the two translational axes T1, T2. Accordingly, the coupling with the contact wheels 60, 62 causes the indicator 70 to register a nominal value corresponding to a calibrated “zero”. Once a variation in the diameter of workpiece 30 is sensed, the linkage between the contact wheels 60, 62 and the indicator 70 causes a value to be displayed in indicator 70 that is indicative of the undulation in the workpiece 30 surface. Preferably, the value displayed by indicator 70 exhibits a direct, or one-to-one, correlation to the change in workpiece outer dimension caused by the undulation. The angled surface 22 of slidable pillow block base 20 is cut at an angle θ relative the first translational axis T1. Preferably, the angle θ is approximately 35 degrees, and more particularly, it is 35 degrees, 15 minutes and 51.8 seconds so that the roller 72 and indicator 70, both of which are mounted at a right angle to the first translational axis T1, indicate the actual change in tubing diameter caused by the undulation. It will be appreciated by those skilled in the art that other roller/angle variations are possible, subject only to the requirement that the configuration produce an accurate measurement of the workpiece 30 out of round dimensions in the indicator 70. Such variations are within the purview of the present invention.

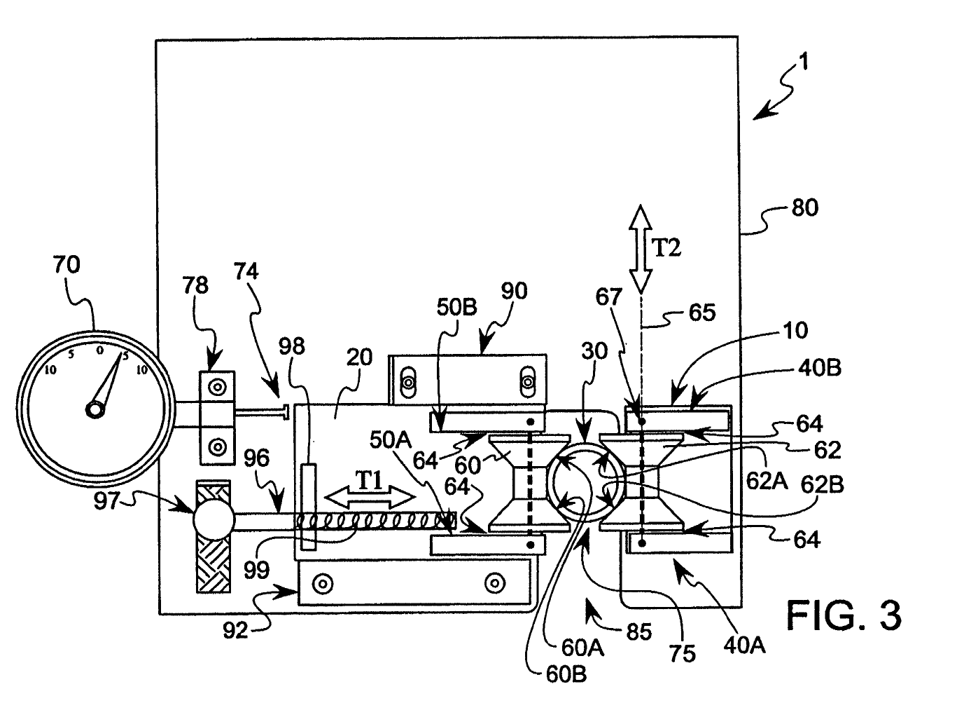

Referring now to FIG. 3, a gage assembly according to an alternate embodiment is shown, where, unlike the embodiment shown in FIG. 2, the conversion of the variation in diameter is measured not by a slanted rolling contact between the slidable pillow block base 20 and the indicator 70, but by a sensor 74 in signal communication with the slidable pillow block base 20. Accordingly, the tension control unit 95 is no longer needed to ensure positive contact between the slidable pillow block base 20 and a roller (not presently shown), although it could be used to ensure proper alignment between sensor 74 and a complementary part, such as a light emitting or reflecting device (not shown) mounted adjacent the sensor 74 on slidable pillow block base 20. Sensor 74 can also be a conventional mechanical linkage to ensure communication of a diameter change in workpiece 30 to indicator 70. For example, with proper gearing, sensor 74 can convert movement along first translational axis T1 into a corresponding deflection reading in indicator 70.

Referring now to FIGS. 4A and 4B, details as to the effect of a surface undulation 31 on a workpiece 30 is shown. In FIG. 4A, a piece of ideally axisymmetric tubing 30 is inserted into workpiece travel zone 75. When the tubing (or a cylindrical solid rod) 30 is coming out of an extruder (not shown), minor motion along the workpiece radial dimension can be accommodated by the slight clearance 64 between the contact wheels and its associated pillow block. Since there are no undulations in workpiece 30, contact wheel 60 does not move along first translational axis T1 relative to contact wheel 62, and both wheels 60 and 62 respond equally to motion along second translational axis T2. Accordingly, no relative motion is imparted to pillow blocks 50A, 50B, and no corresponding change is detected in indicator 70 (not presently shown). By way of contrast, as shown in FIG. 4B, as workpiece 30 with a surface undulation 31 passes through workpiece travel zone 75, clearance 64 has grown significantly in one of the wheels (shown notionally as wheel 60), as the eccentricity of undulation 31 causes wheel 60 to push axially along shaft 65 in the direction defined by second translational axis T2 until it abuts the inner surface of pillow block 50B. In addition, the cammed eccentricity of the undulation 31 will force slidable pillow base block 20 to move along first translational axis T1 relative stationary pillow block base 10. The displacement of the sliding pillow block base 20 due to undulation 31 is transmitted to indicator 70 (not presently shown) to register a reading or data output commensurate with the size of the undulation.

Having described the invention in detail and by reference to preferred embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A gage assembly for the measurement of a workpiece, said gage assembly comprising:
a workpiece engaging mechanism including:
a first contact member defining a workpiece contact surface; and
a second contact member defining a workpiece contact surface, said second contact member configured to be translatably moveable relative to said first contact member and disposed substantially adjacent said first contact member such that a workpiece travel zone is defined by space therebetween;
a mounting mechanism coupled to said workpiece engaging mechanism such that, upon contact between a surface undulation on said workpiece and said workpiece engaging mechanism, relative movement between said first and second contact members proportional to said surface undulation is imparted to at least a portion of said mounting mechanism along at least one translational axis; and
an indicator cooperatively engaged with said mounting mechanism such that said relative movement imparted to said at least a portion thereof is converted to an output in said indicator.

2. A gage assembly according to claim 1, wherein each of said first and second contact members are rotatably mounted within said mounting mechanism and define an axis of rotation such that, upon movement of said workpiece through said workpiece travel zone, at least one of said first and second contact members rotate in response to contact therewith.

3. A gage assembly according to claim 2, wherein said first and second contact members are wheels.

4. A gage assembly according to claim 3, wherein said workpiece contact surface of each of said wheels is defined by a cutout comprising a pair of planar surfaces disposed at substantially right angles to one another.

5. A gage assembly according to claim 4, wherein said workpiece travel zone is shaped such that each planar surface of said first wheel is diametrically opposed to one of said planar surfaces of said second wheel.

6. A gage assembly according to claim 5, wherein each of said wheels are slidably disposed along an axial shaft within said mounting mechanism such that each of said wheels can translate along said shaft in response to contact with said workpiece in order to maintain contact between both of said planar surfaces and said workpiece.

7. A gage assembly according to claim 6, wherein said axial shaft is extends along a second translational axis that is orthogonal to said first translational axis.

8. A gage assembly according to claim 1, wherein said translational axis is substantially aligned with a back and forth motion of said at least a portion of said mounting mechanism along a sliding direction.

9. A gage assembly according to claim 1, wherein said output is a visual indication corresponding to said amount of said undulation.

10. A gage assembly according to claim 8, further comprising:
a surface on said at least a portion of said mounting mechanism angled relative to said translational axis; and
a roller configured to travel along said angled surface, said roller configured to communicate motion imparted to said at least a portion of said mounting mechanism along said first translational axis to said indicator.

11. A gage assembly according to claim 10, wherein said angled surface is disposed relative to said first translational axis approximately 35 degrees.

12. A gage assembly according to claim 10, wherein said angled surface is disposed relative to said first translational axis by 35 degrees, 15 minutes and 51.8 seconds.

13. A gage assembly according to claim 1, wherein said mounting mechanism comprises a stationary base and a slidable base, and said slidable base translates relative said stationary base along said first translational axis.

14. A gage assembly according to claim 13, wherein said mounting mechanism is further defined by:
at least one stationary pillow block member to connect said first contact member to said stationary base; and
at least one slidable pillow block member to connect said second contact member to said slidable base.

15. A gage assembly according to claim 14, further comprising a tension control unit to permit adjustable contact between said indicator and said slidable base.

16. A gage assembly for the measurement of tubing, said gage assembly comprising:
a stationary mounting member including a first contact wheel coupled thereto;
a slidable mounting member adapted to translate back and forth relative to said stationary mounting member along a first translational axis, said slidable mounting member including a second contact wheel coupled thereto;
a tubing travel zone defined by space between said first and second contact wheels; and
an indicator operatively coupled to said slidable mounting mechanism such that relative movement caused in said slidable mounting member along said first translational axis due to said passage of an undulated section in said tubing through said tubing travel zone is converted to an output in said indicator.

17. A gage assembly according to claim 16, wherein said tubing travel zone is further defined by a cutout in each of said first and second contact wheels, each of said cutouts comprising a pair of planar surfaces disposed at substantially right angles to one another.

18. A gage assembly according to claim 17, wherein said tubing travel zone is shaped such that each planar surface of said pair of planar surfaces on said first contact wheel is diametrically opposed to a planar surface of said second contact wheel.

19. A gage assembly according to claim 17, wherein each of said contact wheels are slidably disposed along an axial shaft within said mounting mechanism such that each of said contact wheels can translate along said shaft in response to contact with said tubing in order to maintain contact between both of said planar surfaces and said tubing.

20. A gage assembly according to claim 17, wherein displacement registered as said output is a direct correlation to a change in said outer diameter of said tubing caused by said undulated section.

21. A gage assembly for the measurement of axisymmetric tubing, said gage assembly comprising:
a base plate;
a stationary pillow block base mounted to said base plate, said stationary pillow block base including:
a plurality of spaced-apart pillow blocks; and
a first contact wheel slidably and rotatably disposed along an axial shaft that is mounted between said spaced-apart pillow blocks, said first contact wheel including a tubing contact surface defined by a cutout comprising a pair of planar surfaces angularly disposed relative to one another;
a slidable pillow block base disposed on said base plate, said slidable pillow block base adapted to translate back and forth along a sliding direction, said slidable pillow block base including:
a plurality of spaced-apart pillow blocks; and
a second contact wheel slidably and rotatably disposed along an axial shaft that is mounted between said spaced-apart pillow blocks, said second contact wheel includes a tubing contact surface defined by a cutout comprising a pair of planar surfaces angularly disposed relative to one another, the juxtaposition of said first and second wheels defining a tubing travel zone; and
an indicator operatively responsive to slidable movement in said slidable pillow block base caused by the passage of said tubing through said tubing travel zone.

22. A gage assembly according to claim 21, wherein at least one surface of said slidable pillow block base is angularly disposed relative to said direction of said slidable movement in said slidable pillow block base.

23. A gage assembly according to claim 21, further including a handle disposed on said base plate to facilitate adjustments in at least one of said slidable pillow block base and said stationary pillow block base.

24. A gage assembly according to claim 21, further comprising an adjustable guide in cooperation with said slidable pillow block base; and
a stationary guide in cooperation with said slidable pillow block base to accommodate tubing of various diameters.

25. A gage assembly according to claim 22, wherein said angularly disposed surface is angled between 30 and 40 degrees relative to said direction of slidable movement.

26. A gage assembly according to claim 25, wherein said angularly disposed surface is angled approximately 35 degrees relative to said direction of slidable movement.

27. A gage assembly according to claim 22, further comprising a tension control unit configured to permit adjustable contact between said indicator and said at least one surface of said slidable pillow block base.

28. A gage assembly according to claim 21, wherein said pair of surfaces in each of said contact wheels are disposed at substantially right angles to one another.

29. A method of measuring the diameter of a workpiece, said method comprising:
configuring a workpiece measurement device to include:
a workpiece engaging mechanism comprising:
a first contact member defining a first workpiece contact surface; and
a second contact member defining a second workpiece contact surface, said second contact member configured to be moveable relative to said first contact member and disposed substantially adjacent said first contact member such that a workpiece travel zone is defined by the space therebetween;
a mounting mechanism coupled to said workpiece engaging mechanism such that, upon contact between a surface undulation on said workpiece and said workpiece engaging mechanism, relative movement between said first and second contact members proportional to said surface undulation is imparted to at least a portion of said mounting mechanism along at least one translational axis; and
an indicator cooperatively engaged with said mounting mechanism such that said relative movement imparted to said at least a portion thereof is converted to an output in said indicator;
receiving a portion of said workpiece into said workpiece travel zone; and
measuring said portion of said workpiece to determine said diameter.

30. A method according to claim 29, wherein said step of receiving a portion of said workpiece into a workpiece travel zone further includes receiving said tubing from an extruder.

31. A method according to claim 29, wherein said measurement is made while said workpiece is stationary.

32. A method according to claim 29, wherein each of said first and second contact members:
includes a pair of planar surfaces disposed at substantially right angles relative to one another such that each planar surface is aligned to contact an outer surface of said workpiece, thereby permitting said contact member to rotate in response to moving contact with said workpiece;
is slidably disposed within said mounting mechanism to maintain contact between both of said pair of planar surfaces and said workpiece, thereby facilitating simultaneous measurement of substantially orthogonal surface directions of said workpiece.
